(19) United States
(12) Patent Application Publication
(10) Pub. No.: US 2023/0037827 A1
(43) Pub. Date: Feb. 9, 2023

(54) VOICE SOUND REDUCTION DEVICE

(71) Applicant: Gloria Jean Schroeder, College Park, MD (US)

(72) Inventor: Gloria Jean Schroeder, College Park, MD (US)

(21) Appl. No.: 17/836,206

(22) Filed: Jun. 9, 2022

Related U.S. Application Data
(60) Provisional application No. 63/203,875, filed on Aug. 3, 2021.

(51) Int. Cl. G10K 11/16; H04R 1/10

(52) U.S. Cl. CPC G10K 11/16; H04R 1/1083

(57) ABSTRACT

A voice sound reduction device having a sound dampening cup that conforms to a user's face around the user's mouth, a microphone on an interior of the sound dampening cup electronically paired to a communication device, and a means for positioning the sound dampening cup to a user's face.

### CROSS-REFERENCE TO RELATED APPLICATION

This application claims the benefit of priority of U.S. provisional application No. 63/203,875, filed Aug. 3, 2021, the contents of which are herein incorporated by reference.

### BACKGROUND OF THE INVENTION

The present invention relates to voice noise reduction devices and, more particularly, to a voice noise reduction device for cell phones.

When speaking on a cell phone, a person often disturbs the people around them. This can lead to hostility, animosity, staring, and awkward situations. Many public places such as churches, movie theaters, public transportation, and doctors' offices do not allow the use of cell phones because the voice noise may disrupt others.

In other situations, a person may wish to divulge private or personal information, such as while on their cell phone with a doctor or a bank but may be unable to do so because they are in public and fear eavesdropping.

As can be seen, there is a need for a device to prevent disturbances from people speaking on the phone in public and to prevent eavesdropping on private phone calls. There is also a need for a device that promotes courtesy by not disturbing others with phone calls.

### SUMMARY OF THE INVENTION

In one aspect of the present invention, a voice sound reduction device comprising a sound dampening cup that conforms to a user's face around the user's mouth, a microphone on an interior of the sound dampening cup electronically paired to a communication device, and a means for positioning the sound dampening cup to a user's face.

In another aspect of the present invention, a method of communicating with a voice sound reduction device comprising a sound dampening cup that conforms to a user's face around the user's mouth, providing a microphone on an interior of the sound dampening cup, providing an arm to secure the sound dampening cup to the user's face, pairing a communication device to the microphone, and speaking into the sound dampening cup wherein the sound is captured by the microphone, converted to a radio frequency signal, and electronically transmitted to the communication device, and the sound dampening cup serves as a sound barrier over the user's mouth.

These and other features, aspects, and advantages of the present invention will become better understood with reference to the following drawings, description, and claims.

### BRIEF DESCRIPTION OF THE DRAWINGS

FIG. 1 is a front perspective view of a voice noise reduction device according to an embodiment of the present invention shown in use;

FIG. 2 is a left front perspective view thereof;

FIG. 3 is a right front perspective view thereof;

FIG. 4 is an exploded front perspective view thereof; and

FIG. 5 is a front perspective view thereof shown in use by a method according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a device to reduce a volume of a user's voice that reaches bystanders when the user speaks on a phone. The device comprises a cup that fits over the user's mouth. The cup may be soundproof or sound dampening and may function as a sound barrier. This prevents public disturbances and eavesdropping. This voice noise reduction, sound dampening cup is a simple and effective way of meeting the needs stated above by reducing the reach of a user's voice.

The materials of manufacture of the cup are not particularly limited to the present invention. In some embodiments, the cup is made of a flexible plastic such as vinyl or polyethylene, enabling it to conform to a user's face. Alternatively, the cup may be made of a synthetic rubber such as neoprene. The cup may be produced by injection molding.

When speaking into the sound dampening cup, the sound is captured by the microphone. The microphone converts the sound to a radio frequency signal and electronically transmits the signal to the communication device. The sound dampening cup serves as a sound barrier over the user's mouth, preventing eavesdropping and avoids disturbing others.

In some embodiments, the cup has indentations along an outer edge or outer edges for a placement of a user's fingers. The indentations assist the user in gripping the cup.

In some embodiments, the device communicates with or pairs with the communication device. The communication device, for example, may be a cellular phone, computer, tablet, landline phone, or business telephone. The earpiece communicates with the communication device and may receive a signal from the communication device. The earpiece may then convert that signal to audio for a user. The earpiece may include an earbud for inserting into the user's ear and emitting audio.

A microphone may be secured on an interior of the cup. The microphone may be embedded into the cup or attached to the cup by an adhesive or a fastener or sewn into the cup with a string. The microphone receives or captures the user's voice and is operative to transmit the user's voice to the communication device. The microphone may electronically communicate or pair with the communication device. The microphone may electronically communicate or pair with the earpiece.

In some embodiments of the present invention, a power cord or wired connection supplies power from the communication device to the microphone and earpiece. The power cord or wired connection may also transmit signals between the communication device, the microphone, and/or the earpiece. In some embodiments of the present invention, the microphone and earpiece are each powered by a battery unit. The microphone and/or the earpiece may be connected to the communication device wirelessly, such as via Bluetooth™.

The earpiece may have an ear loop extending from the earpiece. The ear loop may clip onto or around a user's ear to help secure the device.

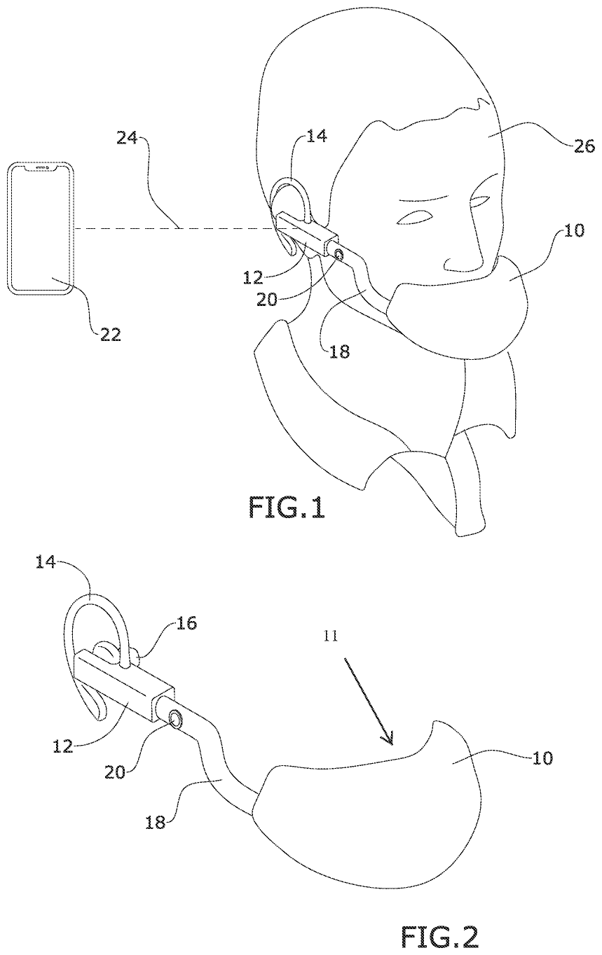

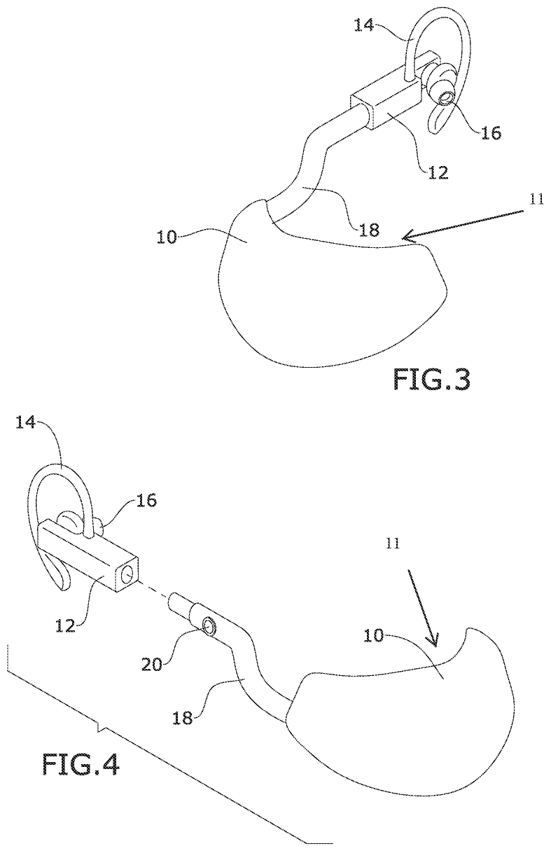

Referring now to FIGS. 1 through 5, a voice noise reduction device according to an embodiment of the present invention includes an arm 18 that extends from a sound dampening cup 10 to an earpiece 12. In some embodiments of the present invention, the arm 18 may transmit power and/or a radio frequency signal. In some embodiments, the sound dampening cup 10 may be secured on a user's 26 face via a positioning means such as the arm 18, straps, or a band.

The sound dampening cup 10 includes a microphone 11 on its interior surface. In some embodiments, the arm 18 is extendable or adjustable in length to conform to a size and shape of a user's face/mouth. The arm 18 is releasably secured to the earpiece 12. An ear loop 14 extends from the earpiece 12. The earpiece 12 has an earbud 16 protruding from it, operative to emit audio into the user's 26 ear. As shown in FIG. 1, the sound dampening cup 10 rests snugly against the user's 26 face around the mouth, restricting the transmission of sound as the user 26 speaks.

The earpiece 12 receives a signal 24 from a cell phone 22 and converts the signal 24 into a sound transmitted to the user's ear via the earbud 16. In some embodiments, the signal 24 is transmitted via a cord that extends from the earpiece 12 and electrically connects to the cell phone 22.

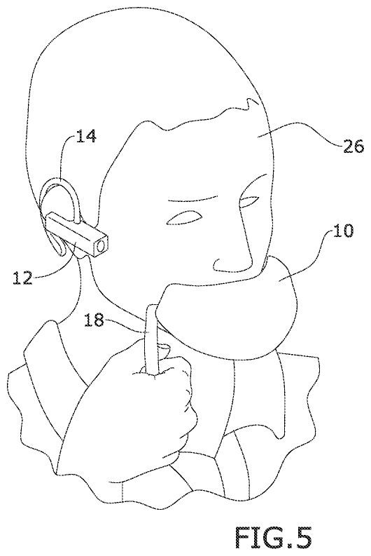

A release button 20 releases the arm 18 from the earpiece 12. The arm 18 is pivotally attached to the sound dampening cup 10 and may pivot or rotate within the sound dampening cup 10 to form a handle for the user 26, as best seen in FIG. 5. The user 26 may then secure or hold the sound dampening cup 10 to the user's face/mouth by way of the arm 18.

It should be understood, of course, that the foregoing relates to exemplary embodiments of the invention and that modifications may be made without departing from the spirit and scope of the invention as set forth in the following claims.

What is claimed is:

1. A voice sound reduction device comprising:
a sound dampening cup that conforms to a user's face around a user's mouth;
a microphone on an interior of the sound dampening cup electronically paired to a communication device; and
a means for positioning the sound dampening cup to a user's face.

2. The voice sound reduction device of claim 1, wherein the means for positioning the sound dampening cup on the user's face is adjustable in length to conform to a size and shape of a user's face.

3. The voice sound reduction device of claim 1, wherein the sound dampening cup is flexible to conform to a size and shape of the user's face.

4. The voice sound reduction device of claim 1, further comprising an earpiece operative to emitting sound into a user's ear.

5. The voice sound reduction device of claim 4, further comprising an earpiece electronically pairs to the communication device.

6. The voice sound reduction device of claim 4, further comprising an earbud extending from the earpiece.

7. The voice sound reduction device of claim 4, further comprising an ear loop operative to affixing the device around a user's ear.

8. The voice sound reduction device of claim 4, wherein the microphone electronically communicates with the earpiece.

9. The voice sound reduction device of claim 1, wherein the voice sound reduction device wirelessly communicates with the communication device.

10. The voice sound reduction device of claim 1, wherein the means for positioning the sound dampening cup on the user's face is an arm.

11. The voice sound reduction device of claim 10, wherein the arm is extendable in length.

12. The voice sound reduction device of claim 10, wherein the arm is releasably secured to an earpiece.

13. The voice sound reduction device of claim 12, wherein the arm is pivotally attached to the sound dampening cup.

14. The voice sound reduction device of claim 13, wherein the arm is operative to secure the sound dampening cup to the user's face.

15. The voice sound reduction device of claim 14, wherein the arm is used as a handle to hold the sound dampening cup to a user's face.

16. A method of communicating with a voice sound reduction device comprising:
providing a sound dampening cup that conforms to a user's face around the user's mouth;
providing a microphone on an interior of the sound dampening cup;
providing an arm to secure the sound dampening cup to user's face;
pairing a communication device to the microphone; and
speaking into the sound dampening cup wherein the sound is captured by the microphone, converted to a radio frequency signal, and electronically transmitted to the communication device, and the sound dampening cup serves as a sound barrier over the user's mouth.
